(19) United States
(12) Patent Application Publication
(10) Pub. No.: US 2019/0355507 A1
(43) Pub. Date: Nov. 21, 2019

(54) MAGNETIC PART AND ELECTRONIC APPARATUS

(71) Applicant: Omron Corporation, Kyoto (JP)

(72) Inventor: Satoru Sasaki, Aichi (JP)

(73) Assignee: Omron Corporation, Kyoto (JP)

(21) Appl. No.: 16/410,811

(22) Filed: May 13, 2019

(30) Foreign Application Priority Data
May 18, 2018 (JP) 2018-095852

(51) Int. Cl. H01F 27/28; H01F 27/26; H01F 27/02

(52) U.S. Cl. CPC H01F 27/2804; H01F 27/02; H01F 27/263

(57) ABSTRACT

A magnetic part including: a coil that generates a magnetic flux when a current flows through the coil; a core that is formed of a magnetic substance that forms a magnetic path of the magnetic flux; a support member that supports the core; and a fixing member that fixes the core to the support member. The core includes a column portion that is vertically provided with respect to a surface where the core is in contact with the support member. The fixing member presses the column portion of the core against the support member. The support member has a recess in a portion of a facing surface that faces the core, where the portion of a facing surface does not face the column portion.

### CROSS-REFERENCES TO RELATED APPLICATIONS

This application is based upon and claims the benefit of priority from Japanese Patent Application No. 2018-095852, filed on May 18, 2018; the entire contents of which are incorporated herein by reference.

### FIELD

One or more embodiments of the present invention relate to a magnetic part that includes a coil and a core formed of a magnetic substance, and an electronic apparatus that includes the magnetic part, and particularly, to a structure for preventing breakage of the core.

### BACKGROUND

For example, an electronic apparatus such as a DC-DC converter is provided with a magnetic part such as a choke coil or a former. Generally, such a magnetic part includes a coil and a core.

A coil is electrically connected to a board, an electrical wiring, or the like of an electronic apparatus, as disclosed in JP-A-2004-303816, JP-A-2011-181804, and JP-A-2009-303285, and generates a magnetic flux when a current flows through the coil. The core is formed of a ferrite magnetic substance material, or the like, and is provided to cover a most part of the coil. Further, the core forms a magnetic path of the magnetic flux generated by the coil.

As disclosed in JP-A-2004-303816, JP-A-2011-181804, and JP-A-2009-303285, the magnetic part is disposed on a support member such as a housing or a metallic plate provided in the electronic apparatus, and is fixed to the support member by a fixing member such as a fixing tool, a screw, or an adhesive.

When the current flows through the coil, the coil or the core radiates heat. Particularly, the amount of radiated heat of a coil or a core provided in a choke coil, a transformer, or the like in which a very high current flows is large. In a case where a temperature of the core exceeds a limit temperature due to the heat, the core does not function as a magnetic substance, and enters a state called thermal runaway, which causes deterioration of performance of the magnetic part.

As a solution, in the related art, for example, a configuration in which a support member is formed of a heat radiator and a core of a magnetic part is in close contact with the support member has been proposed. Further, JP-A-2011-181804 discloses a configuration in which leg portions are provided in a casing that is integrated with a core, the leg portions are fixed to a support member (housing) using screws, and a heat radiation space is provided between the core and the support member. Further, JP-A-2009-303285 discloses a configuration in which both end portions of a lower surface of a magnetic part are supported by a heat transfer layer and projection portions provided on an upper surface of a support member (metallic plate) and the thickness of an adhesive that causes the magnetic part to adhere to the support member is formed to be thin.

### SUMMARY

For example, an external force such as vibration or shock is applied to an in-vehicle electronic apparatus from a vehicle body, a running driving source, or the like. Particularly, large external force such as vibration or shock from the engine is applied to an electronic apparatus that is provided in the vicinity of an engine while a vehicle is running, for example. It is necessary to reliably fix a core of a magnetic part that is provided in the electronic apparatus to a support member using a fixing member so that the core is not separated due to the large external force.

However, since the core is generally formed of a brittle material that is easily broken, such as a ferrite magnetic substance material, in a case where a large force is applied to the core from the fixing member, the core is likely to be broken. Specifically, as disclosed in JP-A-2004-303816, in a structure in which a core is pressed to a support member from the upside using a fixing member, in a case where a space is present between the core and the support member in a direction where a pressing force from the fixing member acts, a large bending stress or shearing stress is applied to the core, and thus, the core is easily broken. Further, in view of manufacturing of the core, there is variance in dimensions of the core, and thus, a warp may occur on a contact surface of the core that is in contact with the support member. In this case, a gap occurs between the core and the support member in the direction where the pressing force from the fixing member acts, and thus, the pressing force to the core from the fixing member and a reaction force to the core from the support member are not operated on the same line. Accordingly, a large bending stress or shearing stress is applied to the core, and thus, the core is easily broken. Further, in a case where the core is broken, the performance of a magnetic part or the performance of an electronic apparatus provided with the magnetic part deteriorates.

As a countermeasure of breakage of the core, there is a method for reducing a load when a core is pressed to a support member using a fixing member to such a degree that the core is not broken and performing adhesion, bonding, or the like, in addition to the fixing member, to fix the core to the support member to reinforce a fixing strength. However, according to the above-mentioned method, the number of manufacturing processes of the magnetic part or the electronic apparatus increases, which causes increase in the manufacturing cost.

One or more embodiments of the invention provide a technique capable of reliably fixing a core to a support member and preventing breakage of the core.

According to an aspect of the invention, there is provided a magnetic part including: a coil that generates a magnetic flux when a current flows through the coil; a core that is formed of a magnetic substance that forms a magnetic path of the magnetic flux; a support member that supports the core; and a fixing member that fixes the core to the support member. The core includes a column portion that is vertically provided with respect to a surface where the core is in contact with the support member. The fixing member presses the column portion of the core against the support member, and the support member has a recess in a portion of a facing surface that faces the core, where the portion of the facing surface does not face the column portion.

Further, according to another aspect of the invention, there is provided an electronic apparatus including: the above-described magnetic part; a board to which the coil of the magnetic part is electrically connected; and a housing that holds the magnetic part and the board.

According to the aspects of the invention, since the column portions of the core are pressed to the support member by the fixing members, a space is not present between the core and the support member in the direction where the pressing forces from the fixing members act. Accordingly, by suppressing a bending stress or shearing stress applied to the core to become small, it is possible to prevent breakage of the core. Further, since the recess is formed in a portion of the facing surface of the support member that faces the core, which is not in contact with the column portions, even though a warp occurs on the facing surface of the core that faces the support member, it is possible to cause only the column portions of the core on which the pressing forces from the fixing members act, on the facing surface of the core, to be in contact with the support member. Further, a gap between the core and the support member is not generated in the direction where the pressing forces from the fixing members act, and the pressing forces from the fixing members to the core and the reaction force from the support member to the core act on the same line. Thus, it is possible to suppress a bending stress or shearing stress applied to the core to become small, to thereby prevent breakage of the core. As a result, it is possible to reliably fix the core to the support member using the fixing members, and to prevent breakage of the core. Further, since a configuration in which pressing forces of fixing members to a core are reduced and adhesion, bonding, or the like is not employed to reinforce a fixing strength in addition to the fixing members, as conventional, it is possible to prevent increase in the number of manufacturing processes of the magnetic part or the electronic apparatus and increase in the manufacturing cost.

Further, in the aspects of the invention, the column portion may be provided in each of both end portions of the core in a direction parallel to the surface where the core is in contact with the support member, and the recess may be provided in the support member to be opened toward a space between the column portions.

Further, in the aspects of the invention, the core may be configured by combining two cores that are formed to have “E” shaped sections in a longitudinal direction such that projection portions formed in both end portions of the two cores in the longitudinal direction are in close contact with each other to form the column portions.

In the aspects of the invention, the support member may further include a stand that is vertically provided lateral to the core, and the fixing member may include a leaf spring, the leaf spring including a root portion fixed to the stand and a tip portion configured to press the column portion of the core against the support member.

Further, in the aspects of the invention, the support member may be formed of a heat radiator that radiates heat emitted from the core.

According to the aspects of the invention, it is possible to reliably fix a core to a support member, and to prevent the core from being broken.

### BRIEF DESCRIPTION OF DRAWINGS

FIG. 1 is a plan view of a main portion of an electronic apparatus according to an embodiment of the invention.

FIG. 2A is a section view of a magnetic part shown in FIG. 1.

FIG. 2B is a section view of the magnetic part shown in FIG. 1.

FIG. 3A is a section view of a magnetic part in the related art.

FIG. 3B is a section view of the magnetic part in the related art.

FIG. 4 is a section view of a magnetic part in the related art.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, the embodiments of the invention will be described with reference to the accompanying drawings. In the respective drawings, the same reference numerals are given to the same portions or corresponding portions.

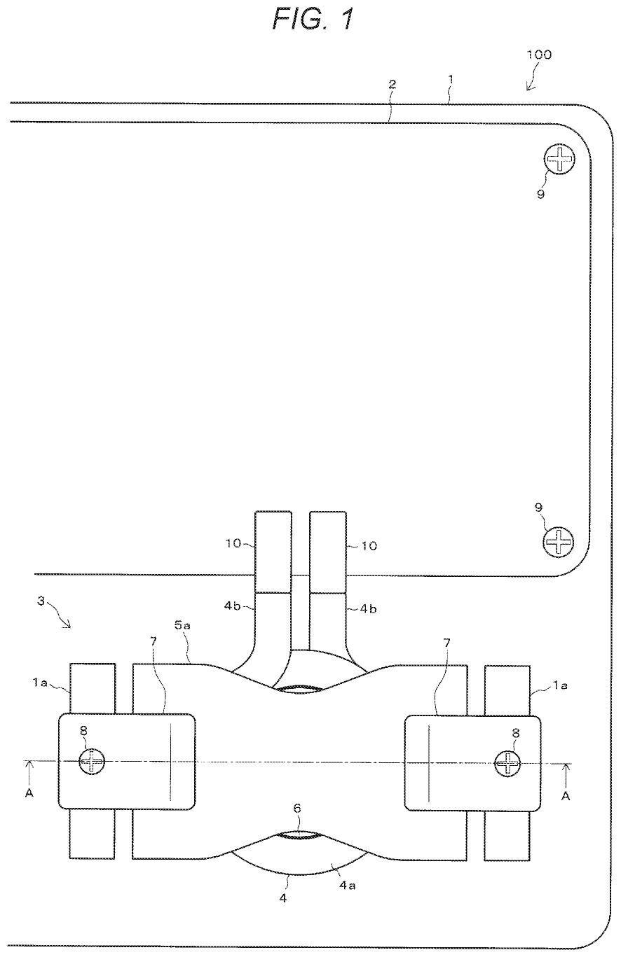

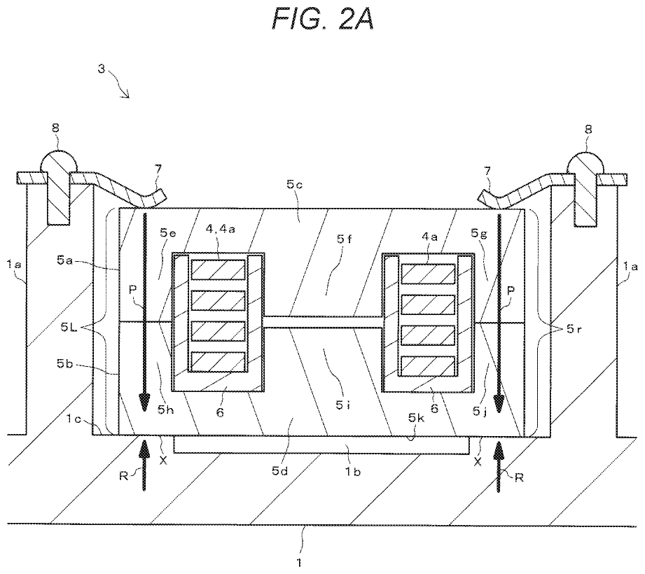

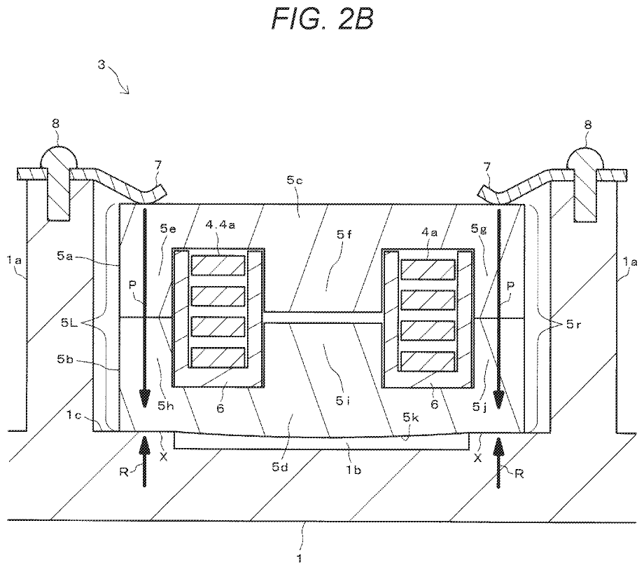

FIG. 1 is a plan view of a main portion of an electronic apparatus 100 according to an embodiment of the invention. FIGS. 2A and 2B are section views (section views taken along A-A in FIG. 1) of a magnetic part 3 shown in FIG. 1.

The electronic apparatus 100 shown in FIG. 1 is an in-vehicle DC-DC converter, for example, and is provided in the vicinity of an engine of a vehicle. A housing 1 of the electronic apparatus 100 is formed of a heat radiator made of a metal material or a synthetic resin. The housing 1 holds a board 2, the magnetic part 3, and the like.

The board 2 is formed of a printed circuit board. The board 2 is fixed by screws 9 at a predetermined position on the housing 1. Although not shown in the figures, a plurality of electronic parts are mounted on the board 2, so that an electric circuit is formed. Further, an electronic part other than the magnetic part 3 is also fixed to the housing 1.

The magnetic part 3 is formed by a choke coil, for example. A coil 4 of the magnetic part 3 is formed by an edgewise coil having a section of a straight angle shape formed by sheet metal working, in this example, and generates a magnetic flux when a current flows through the coil 4. In order to cause a high current to stably flow in the coil 4, a cross-sectional area of a winding (flat wire) of the coil 4 is widened. In each of both edge portions of the coil 4, a terminal portion 4b for causing a current to flow in the coil 4 is provided. Each terminal portion 4b is extracted on one side of each of cores 5a and 5b (FIGS. 2A and 2B), and is electrically connected to one end of an electric wiring 10. The other end of the electric wiring 10 is electrically connected to the board 2 (FIG. 1). That is, the coil 4 is electrically connected with respect to the board 2.

As shown in FIG. 2A, or the like, each of the cores 5a and 5b is formed by a ferrite core of which a section in a length direction (a longitudinal direction in FIG. 1 and FIGS. 2A and 2B) has an “E” shape. That is, the cores 5a and 5b are formed of a ferrite magnetic substance material. The cores 5a and 5b form a magnetic path of the magnetic flux generated by the coil 4.

In FIG. 2A, or the like, the upper core 5a disposed on an upper side includes a base portion 5c, and three projection portions 5e, 5f, and 5g that protrude downwards from the base portion 5c. The projection portions 5e, 5f, and 5g are disposed in a line in the longitudinal direction (the longitudinal direction in FIG. 1 to FIG. 2B) of the upper core 5a.

The lower core 5b that is disposed on a lower side includes a base portion 5d, and three projection portions 5h, 5i, and 5j that protrude upwards from the base portion 5d. The projection portions 5h, 5i, and 5j are disposed in a line in the length direction (the longitudinal direction in FIG. 1 to FIG. 2B) of the lower core 5b.

A protruding height, from the base portions 5c and 5d, of the projection portions 5e, 5g, 5h, and 5j that are disposed on the right and left is greater than that of the projection portions 5f and 5i that are disposed at the center of the cores 5a and 5b.

Tip surfaces (lower ends) of the left and right projection portions 5e and 5g of the upper core 5a and tip surfaces (upper ends) of the left and right projection portions 5h and 5j of the lower core 5b are in close contact with each other, so that the cores 5a and 5b are combined. Further, in both end portions of the cores 5a and 5b in the longitudinal direction, a column portion 5L formed by the projection portions 5e and 5h and one end portions of the base portions 5c and 5d, and a column portion 5r formed by the projection portions 5g and 5j and the other end portions of the base portions 5c and 5d are formed. The projection portion 5f of the upper core 5a and the projection portion 5i of the lower core 5b face each other with a gap of a predetermined size.

The projection portions 5f and 5i are disposed inside a winding portion 4a of the coil 4. The column portions 5L and 5r are disposed outside the winding portion 4a of the coil 4. That is, the coil 4 is disposed between the column portions 5L and 5r of the cores 5a and 5b, and the winding of the coil 4 is wound around the projection portions 5f and 5i. Thus, when a high current flows in the coil 4, a predetermined inductance is realized, and a direct current superimposition characteristic of the inductance is enhanced by the gap between the projection portions 5f and 5i.

Between the cores 5a and 5b, and the coil 4, a bobbin 6 is provided. The bobbin 6 is formed of an insulator made of a synthetic resin, and insulates the cores 5a and 5b, and the coil 4.

As shown in FIG. 1, the cores 5a and 5b are disposed at a predetermined position on the housing 1, and cover a most part of the winding portion 4a of the coil 4. Further, as shown in FIG. 2A, or the like, the lower core 5b is supported by the housing 1 from a lower side. On a contact surface X of the lower core 5b and the housing 1, a lubricating oil, a sheet, or the like having thermal conductivity and insulation performance may be interposed. The housing 1 is an example of a “support member” of one or more embodiments of the invention.

Stands 1a are vertically provided on the housing 1 to be positioned on both sides of the cores 5a and 5b in the longitudinal direction. The heights of the stands 1a from the housing 1 are set to be higher than the heights of the cores 5a and 5b. On each stand 1a, a root portion of a leaf spring 7 is fixed by the screw 8. A tip portion of each leaf spring 7 presses each of both end portions of the upper core 5a in the longitudinal direction. That is, each leaf spring 7 presses each of the column portions 5L and 5r of the cores 5a and 5b onto the housing 1 from above at the tip portion thereof to fix the cores 5a and 5b to the housing 1. The leaf spring 7 and the screw 8 are an example of a “fixing member” of one or more embodiments of the invention. As another example, a structure in which the height of the stand 1a is set to be the same or lower than the height of the cores 5a and 5b, the longitudinal of the leaf spring 7 is set to become long, and each of the cores 5a and 5b is pressed from the top using the leaf spring 7 may be used.

A load when the leaf spring 7 presses each of the cores 5a and 5b is set to such a size that each of the cores 5a and 5b is not separated from the housing 1 even in a case where an external force such as large vibration or shock is applied to the electronic apparatus 100 or the magnetic part 3 from an engine of a vehicle, for example.

The column portions 5L and 5r of the cores 5a and 5b are provided, at both end portions of the cores 5a and 5b in the longitudinal direction that are parallel to the contact surface X of the cores 5a and 5b, and the housing 1, to be vertical with respect to the contact surface X. An upper end portion of each of the column portions 5L and 5r is pressed downwardly by the leaf spring 7, and a lower end portion of each of the column portions 5L and 5r is supported by the housing 1.

A recess 1b is formed in a portion of a facing surface 1c of the housing 1 that faces the lower core 5b, which is not in contact with the column portions 5L and 5r of the cores 5a and 5b. Accordingly, a portion other than the lower end portions of the column portions 5L and 5r of the cores 5a and 5b is not in contact with the housing 1.

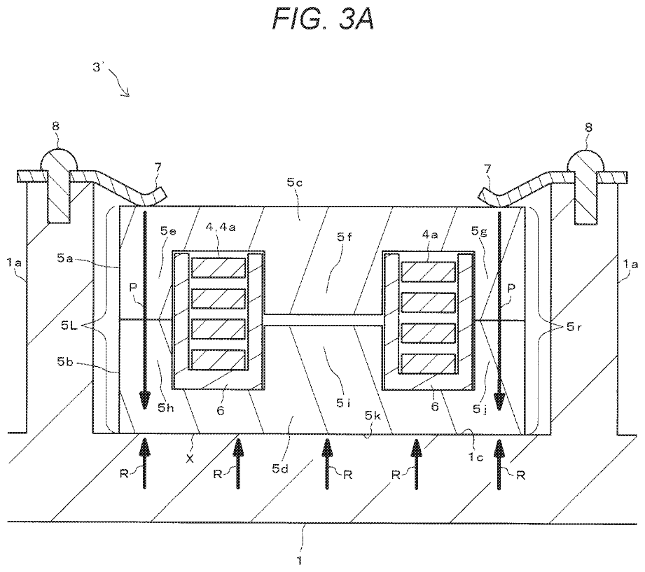

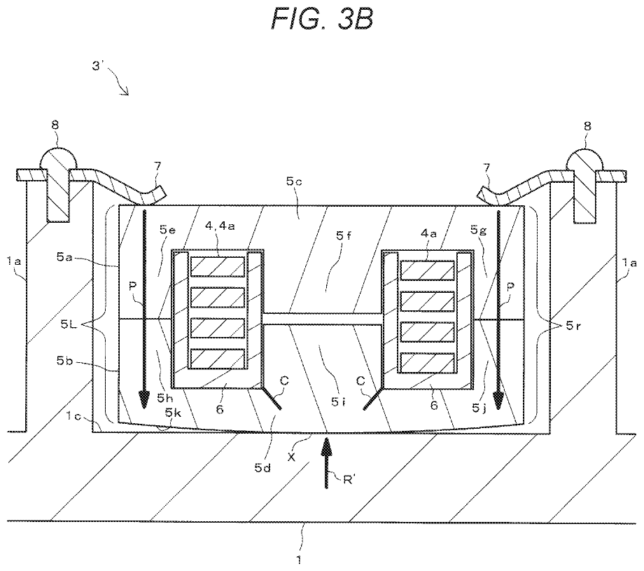

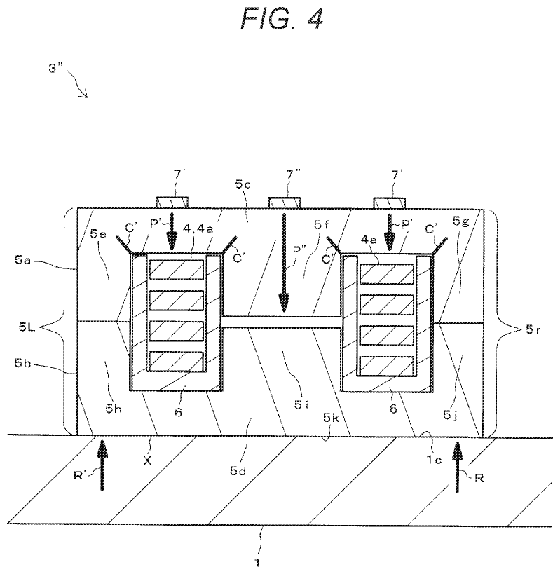

FIGS. 3A, 3B, and FIG. 4 are section views of magnetic parts 3′ and 3″ in the related art. In the related art, as shown in FIGS. 3A, 3B, and FIG. 4, a facing surface 1c of a housing 1 that faces a lower core 5b is flat and flush, and an entire region of a lower surface of the lower core 5b is in contact with the housing 1.

Accordingly, as shown in FIG. 3A, in an ideal state where a facing surface 5k of the lower core 5b that faces the housing 1 is flat and a warp does not occur on the facing surface 5k, a reaction force R from the housing 1, with respect to a pressing force P for pressing downward the cores 5a and 5b by a leaf spring 7, acts in a state of being dispersed in a base portion 5d of the lower core 5b.

However, due to problems in manufacturing of the cores 5a and 5b, there is variance in dimensions of the cores 5a and 5b, and thus, as shown in FIG. 3B, a warp that protrudes toward the housing 1 as it goes to the center may occur on the facing surface 5k of the lower core 5b that faces the housing 1. In this case, even though upper end portions of the column portions 5L and 5r of the cores 5a and 5b are pressed downward by the leaf springs 7, only the highest central portion of the facing surface 5k of the lower core 5b is in contact with the housing 1, and thus, gaps are generated between the lower core 5b and the housing 1 in a direction (in a downward direction in FIG. 3B) where the pressing forces P from the leaf springs 7 act. Accordingly, the pressing forces P from the leaf springs 7 to the cores 5a and 5b and a reaction force R′ from the housing 1 to the cores 5a and 5b do not act on the same line. Accordingly, a large bending stress or shearing stress is applied to the lower cores 5b, and thus, the lower core 5b is easily broken. Particularly, as shown in FIG. 3B, cracks C occur from root portions of the projection portion 5i of the lower core 5b toward the base portion 5d, and thus, the lower core 5b is easily broken.

Further, due to a design problem of the electronic apparatus 100 or the magnetic part 3, as shown in FIG. 4, there is a case where a central portion of the upper core 5a is pressed downward using a leaf spring 7′ or a leaf spring 7″, in place of the upper end portions of the column portions 5L and 5r of the cores 5a and 5b. In this case, since a space (a space where the coil 4 is contained or a gap between the projection portions 5f and 5i) is present from the upper core 5a to the housing 1, in a direction (in a downward direction in FIG. 4) of pressing forces P′ and P″ of the respective leaf springs 7′ and 7″, a large bending stress or shearing stress is applied to the upper core 5a, and thus, the upper core 5a easily cracks. Particularly, as shown in FIG. 4, cracks C′ occur from root portions of the projection portion 5f of the upper core 5a toward the base portion 5c, and thus, the upper core 5a is easily broken.

On the other hand, in this embodiment, as shown in FIG. 2A, or the like, since the column portions 5L and 5r of the cores 5a and 5b are pressed to the housing 1 by the leaf springs 7, a space is not present between the cores 5a and 5b and the housing 1, in the direction where the pressing force P from the leaf spring 7 acts. Accordingly, by suppressing a bending stress or shearing stress applied to the upper core 5a to become small, it is possible to prevent breakage of the upper core 5a.

Further, the recess 1b is formed in a portion of the facing surface 1c of the housing 1 that faces the cores 5a and 5b, which is not in contact with the column portions 5L and 5r of the cores 5a and 5b. Accordingly, as shown in FIG. 2B, even though a warp that protrudes toward the housing 1 as it goes to the center thereof occurs on the facing surface 5k of the lower core 5b that faces the housing 1, the highest central portion of the facing surface 5k of the lower core 5b is inserted into the recess 1b, and thus, the central portion is not in contact with the housing 1. Accordingly, it is possible to cause only the lower end portions of the column portions 5L and 5r of the cores 5a and 5b on which the pressing forces P from the leaf springs 7 act to be in contact with the housing 1. Further, a gap between the lower core 5b and the housing 1 is not generated in the direction where the pressing force P from the leaf spring 7 acts, and the pressing forces P from the leaf springs 7 to the cores 5a and 5b and the reaction forces R from the housing 1 to the cores 5a and 5b act on the same line. Thus, it is possible to suppress a bending stress or shearing stress applied to the lower core 5b to become small, to thereby prevent breakage of the lower core 5b.

As a result, it is possible to reliably fix the cores 5a and 5b to the housing 1 using the leaf springs 7, and to prevent breakage of the cores 5a and 5b. Further, it is possible to prevent performance of the magnetic part 3 and the electronic apparatus 100 from deteriorating due to the breakage of the cores 5a and 5b.

Further, since a configuration in which pressing forces of the leaf springs 7 to the cores 5a and 5b are reduced, and in this case, adhesion, bonding, or the like is performed as reinforcement means, as in the related art, is not employed, it is possible to prevent increase in the number of manufacturing processes of the magnetic part 3 or the electronic apparatus 100 and increase in the manufacturing cost.

Further, in this embodiment, the column portions 5L and 5r are provided at both end portions of the cores 5a and 5b in the longitudinal direction, in the direction that is parallel to the contact surface X of the lower core 5b and the housing 1. Thus, by pressing the respective column portions 5L and 5r onto the housing 1 from above using the leaf springs 7, it is possible to stably and reliably fix the cores 5a and 5b to the housing 1.

Further, in this embodiment, the housing 1 of the electronic apparatus 100 is formed of a heat radiator, and the cores 5a and 5b are fixed to the housing 1 to be in close contact therewith. Thus, when the current flows through the coil 4, it is possible to transfer heat emitted from the cores 5a and 5b to the housing 1 from the column portions 5L and 5r, and to radiate the heat from the housing 1 to the outside. Further, it is possible to prevent the cores 5a and 5b from entering a thermal runaway state, to thereby prevent deterioration of the performance of the magnetic part 3 or the electronic apparatus 100.

The invention may employ various embodiments, in addition to the above-described embodiment. For example, in the above-described embodiment, an example in which the cores 5a and 5b are supported or fixed onto the housing 1 of the electronic apparatus 100 is shown, but the invention is not limited thereto. For example, a configuration in which the cores 5a and 5b are supported by a support member other than the housing 1, the cores 5a and 5b are fixed to the support member using the leaf springs 7, and the support member is fixed to the housing 1 using fixing means such as screws or an adhesive may be employed.

Further, in the above-described embodiment, an example in which two ferrite cores 5a and 5b having “E” shaped sections are vertically combined to form a core is shown, but the invention is not limited thereto. For example, a configuration in which a core having an “E” shaped section and a core having an “I” shaped section are combined to form a core may be employed. Further, only one core having a different shape may be used, or three or more cores may be combined to form a core. Further, a core formed of a magnetic material other than ferrite may be used. In addition, the number of column portions formed in the core may be one, or may be three or more.

Further, in the above-described embodiment, an example in which an edge-wise coil is used as the coil 4 is shown, but the invention is not limited thereto. For example, a coil in which a winding is formed by a wiring pattern on a printed board may be used. In addition, a coil in which a section of a winding is a different shape such as a square shape, a circular shape, or the like other than a straight angle shape may be used.

Further, in the above-described embodiment, an example in which the cores 5a and 5b are fixed to the housing 1 using the leaf springs 7 and the screws 8 is shown, but the invention is not limited thereto. For example, a fixing tool of a metallic material or a synthetic resin may be used as a fixing member that fixes a core. In addition, two or more fixing members as described above may be combined, or the fixing member and an adhesive, an adhesive tape, or the like may be used together. Further, the number of locations where a core is held by being pressed by a fixing member may be one or plural. Furthermore, the number of locations where a core is held by a support member may be one or plural.

Further, in the above-described embodiment, an example in which one recess 1b is provided in the housing 1 is shown, but the invention is not limited thereto. For example, a plurality of recesses may be provided in a facing portion of the housing 1 that faces a portion other than the column portions 5L and 5r of the cores 5a and 5b. Further, in order to easily transfer heat of the cores 5a and 5b to the housing 1, a lubricating oil, an elastic sheet, or the like having thermal conductivity and insulation performance may be provided in the recess. In addition, on the surface X where the cores 5a and 5b are in contact with the housing 1, a lubricating oil, an elastic sheet, or the like having thermal conductivity and insulation performance may be interposed.

Further, in the above-described embodiment, an example in which the invention is applied to the magnetic part 3 formed of a choke coil is shown, but the invention may be applied to another magnetic part such as a transformer.

Further, in the above-described embodiment, an example in which the invention is applied to the electronic apparatus 100 formed of an in-vehicle DC-DC converter that is provided in the vicinity of an engine of a vehicle and the magnetic part 3 provided in the electronic apparatus 100 is shown, but the invention may be applied to different in-vehicle electronic apparatuses, electronic apparatuses other than the in-vehicle electronic apparatus, and a magnetic part provided therein.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A magnetic part comprising:
a coil that generates a magnetic flux when a current flows through the coil;
a core that is formed of a magnetic substance that forms a magnetic path of the magnetic flux;
a support member that supports the core; and
a fixing member that fixes the core to the support member,
wherein the core comprises a column portion that is vertically provided with respect to a surface where the core is in contact with the support member,
wherein the fixing member presses the column portion of the core against the support member, and
wherein the support member has a recess in a portion of a facing surface that faces the core, where the portion of the facing surface does not face the column portion.

2. The magnetic part according to claim 1,
wherein the column portion is provided in each of both end portions of the core in a direction parallel to the surface where the core is in contact with the support member, and
wherein the recess is provided in the support member to be opened toward a space between the column portions.

3. The magnetic part according to claim 1,
wherein the core is configured by combining two cores that are formed to have “E” shaped sections in a longitudinal direction such that projection portions formed in both end portions of the two cores in the longitudinal direction are in close contact with each other to form the column portions.

4. The magnetic part according to claim 1,
wherein the support member further comprises a stand that is vertically provided lateral to the core, and
wherein the fixing member comprises a leaf spring, the leaf spring comprising a root portion fixed to the stand and a tip portion configured to press the column portion of the core against the support member.

5. The magnetic part according to claim 1,
wherein the support member is formed of a heat radiator that radiates heat emitted from the core.

6. An electronic apparatus comprising:
the magnetic part according to claim 1;
a board to which the coil of the magnetic part is electrically connected; and
a housing that holds the magnetic part and the board.
